(19) United States
(12) Patent Application Publication
(10) Pub. No.: US 2016/0208042 A1
(43) Pub. Date: Jul. 21, 2016

(54) MULTI-COMPONENT EPOXY RESIN COMPOSITION

(71) Applicant: BASF SE, Ludwigshafen (DE)

(72) Inventors: Rainer KLOPSCH, Worms (DE); Monika CHARRAK, Bobenheim-Roxheim (DE); Joachim ZWECKER, Weinheim (DE)

(73) Assignee: BASF SE, Ludwigshafen (DE)

(21) Appl. No.: 15/026,475

(22) PCT Filed: Sep. 30, 2014
(86) PCT No.: PCT/EP2014/070917

§ 371 Date: Mar. 31, 2016

(30) Foreign Application Priority Data
Oct. 1, 2013 (EP) 13186860.6

(51) Int. Cl. C08G 59/56; C09J 163/00; B29C 65/00; B29C 65/48; B29C 70/84; C08G 59/24; C09J 5/00

(52) U.S. Cl. CPC C08G 59/56; C08G 59/245; C09J 163/00; C09J 5/00; B29C 65/483; B29C 70/845; B29C 66/303; C09J 2203/102; C09J 2463/00; B29K 2063/00

(57) ABSTRACT

The invention relates to multi-component epoxy resin compositions, comprising the following components: a) at least one epoxy resin component containing a1) at least one epoxy resin and a2) at least one compound of the general formula (I), wherein R1 and R2 independently from one another stand for hydrogen, C1-C6-alkyl, C1 -C4-alkoxy-C1-C4-alkyl, C5-C6-cycloalkyl, phenyl, phenyl-C1-C4-alkyl, C2-C6-alkenyl, or C2-C6-alkynyl, or R1 and R2 jointly stand for a C3-C11 alkylene group; R3 and R4 independently from one another stand for hydrogen, C1-C6-alkyl, C1-C4-alkoxy-C1-C4-alkyl, C5-C6-cycloalkyl, phenyl, phenyl-C1-C4-alkyl, C2-C6-alkenyl, or C2-C6-alkynyl, or R3 and R4 jointly stand for a C4-C6 alkylene group; b) at least one hardener component containing b1) at least one amine curing agent, wherein the epoxy resin component (a) and/or the hardener component (b) contain at least one additional constituent part c1), which is selected from aliphatic polyether polyols and aliphatic polyetheramine polyols. Multi-component epoxy resin compositions are suited for injection mortar systems, in particular for chemical fixing or anchoring systems.

### DESCRIPTION

The present invention relates to new multicomponent epoxy resin compositions comprising at least one epoxy resin component and at least one curing component that are suitable for injection mortar systems, more particularly for chemical fastening or anchoring systems.

In the technology of chemical fastening or anchoring, curable compositions referred to as injection mortar systems are inserted together with an anchoring element—for example, a metal pin, a metal rod, or metal hooks—into a recess—a drilled hole, for example—located in a mineral substrate, such as stone or concrete, for example. Full curing of the injection mortar results in a solid bond between the anchoring element and the substrate. Two types of application essentially have become established in this context. As capsule system, wherein the components that react with one another are located in separate compartments, consisting either of glass or of plastics pouches. The capsules are inserted into a drilled hole and the components are mixed by the driving insertion of an anchoring element with rotary percussion, thereby initiating the reaction of curing between the components. In addition to these systems, injection systems have become established wherein the components are dispensed into separate film pouches. Then, using a dispenser, the components are mixed shortly prior to application, the mixture is introduced into a drilled hole, and the anchor is plugged into the recess—a drilled hole, for example—filled with the components of the composition.

The curable compositions used for injection mortar systems typically comprise an organic binder which cures fully, with crosslinking, in the application. Proposed for this purpose are unsaturated polyester resins (UP resins), vinyl resins, and also epoxy resins, especially multicomponent epoxy resin compositions.

Fundamentally, curable compositions for chemical fastening are required to meet a complex profile of requirements, determined substantially by the properties of the binder used. On the one hand the ultimate strength of the bond of curable composition with anchoring element must be high. Important at the same time is a large temperature window for the workability, meaning first that the binders must cure sufficiently rapidly and completely at low temperatures of below 5° C. in order to obtain good early strengths and high ultimate strengths even at low working temperatures. On the other hand, the reactivity of the binder system must not be too high, so that the processing time window is sufficiently long even when processing temperatures are relatively high (e.g., in the range from 30 to 50° C.), said window still allowing correction to the position of the anchoring element. High heat stability is further desired. Moreover, in the case of multicomponent compositions, the viscosity of the components must be sufficiently low to ensure thorough mixing of the constituents at processing. These complex profiles of properties require binder properties that are in some cases divergent, thus not always allowing all of the desired properties to be actualized in an equal way.

WO 2005/090433 describes, for example, multicomponent epoxy resin compositions for fastening use, comprising an epoxy resin component (a), which includes curable epoxides, and a curing component (b), the curing component comprising a Mannich base formulation.

DE 102011006286 describes a hybrid binder for chemical fastening that comprises an organic binder based on epoxy resin, and an inorganic binder, the organic binder comprising a water-based curing agent. The water, however, may lead to compatibility problems.

Known from WO 2011/157617 are epoxy resin formulations which as well as the epoxy resin and an aminic curing agent comprise a compound of the general formula I:

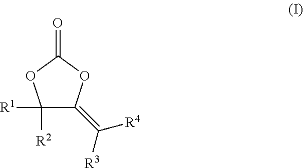

in which

R¹ and R² independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R¹ and R² together are a C₃-C₁₁-alkylene group; and

R³ and R⁴ independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R³ and R⁴ together are a C₄-C₆-alkylene group. While these formulations do cure rapidly at low working temperatures, the ultimate strengths achievable when formulations of this kind are used in chemical fastening systems are no more than moderate.

It is an object of the present invention, therefore, to provide multicomponent epoxy resin compositions where are suitable for chemical fastening and which have properties, relative to those of the existing multicomponent epoxy resin compositions, that are advantageous, especially with a view to use in chemical fastening systems. The compositions ought in particular to still be workable even at relatively low temperatures, and ought to exhibit a sufficient working time window even at relatively high temperatures. Very particularly, high ultimate strengths ought to be obtained, even if the compositions are processed at low temperatures. These compositions ought further to have a high heat stability, in order to ensure sufficiently high strength of the bond even at relatively higher temperatures, such as may occur on areas of buildings in the event of incoming solar radiation, for example.

These and further objects are achieved by the multicomponent epoxy resin compositions described below. The invention therefore relates to multicomponent epoxy resin compositions which comprise the following components:

a) at least one epoxy resin component which comprises
a1) at least one epoxy resin and
a2) at least one compound of the general formula I,

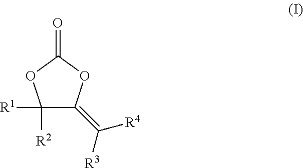

in which
R¹ and R² independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R¹ and R² together are a C₃-C₁₁-alkylene group;
R³ and R⁴ independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R³ and R⁴ together are a C₄-C₆-alkylene group;

b) at least one curing component which comprises
b1) at least one amine curing agent,
   the epoxy resin component (a) and/or the curing component (b) comprising at least one further constituent c1) selected from aliphatic polyether polyols and aliphatic polyetheramine polyols.

The multicomponent epoxy resin compositions of the invention possess a series of advantages. When the compositions are used for chemical fastening, high ultimate strengths and high tensile strengths can be achieved. The compositions are still workable even at relatively low temperatures, and cure with sufficient rapidity and completeness without detriment to the strength of the bond. The compositions have a sufficiently long working time window after the mixing of epoxy resin component and curing component, and even at relatively high temperatures. Moreover, the bonds have a high heat stability. The viscosity can be set to a range desirable for use in chemical fastenings, without detriment to the quality of the bond.

The multicomponent epoxy resin compositions of the invention comprise at least one epoxy resin component (a) and at least one curing component (b), these components generally being formulated separately and being mixed with one another only at or shortly before application, and also component c1). The major amount of component c1) is preferably formulated in the curing component. However, all or part of component c1) may also be formulated in the epoxy resin component (a). Preferably at least 50 wt %, more particularly at least 80 wt %, or the total amount of component c1) is formulated in curing component (b). The total amount of component c1) is typically in the range from 0.5 to 20 wt %, more particularly in the range from 1 to 15 wt %, especially in the range from 2 to 10 wt %, based on the total weight of components (a) and (b).

In one first embodiment of the invention, component c1) comprises at least one polyether polyol, as for example a poly-C₂-C₄-alkylene glycol such as polyethylene glycol, polypropylene glycol, poly(ethylene glycol-co-propylene glycol) copolymers, and polytetrahydrofuran (PTHF). Suitable poly-C₂-C₄-alkylene glycols preferably have a number-average molecular weight in the range from 400 to 50 000 daltons and more particularly in the range from 500 to 20 000 daltons. Suitable poly-C₂-C₄-alkylene glycols generally have terminal hydroxyl groups. The poly-C₂-C₄-alkylene glycols preferably have a hydroxyl number in the range from 2 to 200 mg KOH/g.

In this first embodiment, component c1) preferably comprises polytetrahydrofuran (PTHF). By this is meant linear or branched polytetramethylene ethers or poly-1,4-butylene ethers. PTHF is prepared generally by cationic polymerization of tetrahydrofuran or by polycondensation of butanediol. PTHF and processes for its preparation are known, as for example from U.S. Pat. No. 4,658,065, WO 96/09335, DE 19758296 and WO 2003/018666. Suitable PTHF preferably has a number-average molecular weight in the range from 400 to 50 000 daltons and more particularly in the range from 500 to 20 000 daltons. The PTHF preferably has a hydroxyl number in the range from 2 to 200 mg KOH/g. Especially suitable are the products sold by BASF SE under the PolyTHF® designation.

In a second, preferred embodiment, component c1) comprises at least one aliphatic polyetheramine polyol, more particularly a branched poly-C₂-C₄-alkylene ether amine polyol, or a mixture thereof with a poly-C₂-C₄-alkylene glycol, more particularly with PTHF. The aliphatic polyetheramine polyol is preferably a main constituent of component c1) and more particularly makes up at least 80 wt % of component c1). The aliphatic polyetheramine polyol is preferably the sole constituent of component c1). The aliphatic polyetheramine polyol is preferably selected from branched poly-C₂-C₄-alkylene ether amine polyols.

By polyetheramine polyols are meant aliphatic polyetheramines having terminal hydroxyl groups. Polyetheramine polyols are prepared generally by condensation of di-and/or trialkanolamines, more particularly by condensation of di- and/or tri-C₂-C₄-alkanolamines. Where preparation takes place starting from trialkanolamines or from mixtures of trialkanolamines with dialkanolamines, as for example starting from tri-C₂-C₄-alkanolamines or mixtures thereof with di-C₂-C₄-alkanolamines, the products are branched polyetheramine polyols, or branched poly-C₂-C₄-alkylene ether amine polyols, respectively. Aliphatic polyetheramine polyols, more particularly branched poly-C₂-C₄-alkylene ether amine polyols, are known, as for example from U.S. Pat. No. 2,178,173, U.S. Pat. No. 2,290,415, U.S. Pat. No. 2,407,895, DE 4003243, and WO 2009/047269.

Preference is given to the branched polyetheramine polyols described in WO 2009/047269, more particularly to the branched poly-C₂-C₄-alkylene ether amine polyols described therein. Preferred starting materials for preparing the preferred, branched poly-C₂-C₄-alkylene ether amine polyols are tri-C₂-C₄-alkanolamines such as triethanolamine, tripropanolamine, triisopropanolamine or tributanolamine, which are reacted optionally in combination with dialkanolamines, such as diethanolamine, dipropanolamine, diisopropanolamine, dibutanolamine, N,N′-dihydroxyalkylpiperidine (alkyl=C₁-C₈), or in combination with polyether diols or more highly functional polyetherols based on ethylene oxide and/or propylene oxide. Particularly preferred branched poly-C₂-C₄-alkylene ether amine polyols are those obtainable by condensation of at least one tri-C₂-C₄-alkanolamine and more particularly by condensation of at least one tri-C₂-C₄-alkanolamine selected from triethanolamine, tripropanolamine, triisopropanolamine or mixtures thereof.

The OH number of the polyetheramine polyols, more particularly the preferred branched poly-C₂-C₄-alkylene ether amine polyols, is usually at least 100 mg KOH/g or more, preferably at least 150 mg KOH/g or more, and is situated in particular in the range from 150 to 700 mg KOH/g. The polyetheramine polyols, more particularly the preferred branched poly-C₂-C₄-alkylene ether amine polyols, generally have a number-average molar weight Mₙ in the range of 1000 and 50 000, and preferably in the range of 1500 and 20 000 g/mol. The weight-average molar weight Mw is situated usually in the range of 1200 and 300 000, preferably from 2000 to 200 000 and more particularly from 3000 to 150 000 g/mol. The molecular weights reported here are based on the values measured by gel permeation chromatography using hexafluoroisopropanol as mobile phase and polymethyl methacrylate (PMMA) as standard.

Preference is given to those aliphatic polyetheramine polyols, more particularly those poly-C₂-C₄-alkylene ether amine polyols, in which the aliphatic polyetheramine polyol has 1 to 10 mol/kg of branching sites.

Component (a) generally comprises at least one epoxy resin. Epoxy resins contemplated for component (a) include more particularly those which are customarily used in curable epoxy resin compositions. Mention may be made more particularly of compounds having 1 to 10 epoxide groups, preferably having at least two epoxide groups, in the molecule. The epoxide group content of typical epoxy resins is in the range from 120 to 3000 g/equivalent, calculated as so-called epoxide equivalent in accordance with DIN 16945.

Preferred among these are those known as glycidyl-based epoxy resins, more particularly those prepared by etherification of aromatic, aliphatic or cycloaliphatic polyols with epichlorohydrin. Substances of this kind are frequently also referred to as polyglycidyl ethers of aromatic, or as polyglycidyl ethers of aliphatic or cycloaliphatic polyols, respectively.

The epoxy resins may be liquid resins, solid resins or mixtures thereof. Liquid resins differ from solid resins in lower viscosity. Moreover, liquid resins generally have a higher fraction of epoxide groups and, accordingly, a lower epoxide equivalent. Liquid resins are frequently also referred to as reactive diluents, since they lower the viscosity of the epoxy resin component.

The epoxide group content of typical liquid resins is customarily in the range from 120 to 200 g/equivalent, and that of the solid resins is in the range from 250 to 3000 g/equivalent, calculated as so-called epoxide equivalent in accordance with DIN 16945. The epoxy resin component a1) preferably has an average epoxide equivalent in the range from 120 to 300 g/equivalent.

The viscosity of the liquid resins at 25° C. is customarily in the range from 1 to 20 Pas, preferably in the range from 5 to 15 Pas. The viscosity of the solid resins at 25° C. is customarily in the 5 to 40 Pas range, preferably in the range from 20 to 40 Pas. The viscosities reported here are the values determined in accordance with DIN 53015 at 25° C. in form of 40% strength solutions of the resins in methyl ethyl ketone.

Suitable epoxy resins are available commercially for example under the brand designations EPILOX®, EPONEX®, EPIKOTE®, EPONOL®, D.E.R., ARALDIT® or ARACAST®.

In one preferred embodiment the epoxy resin a1) comprises at least one polyglycidyl ether of an aromatic polyol. Examples of polyglycidyl ethers of aromatic polyols are the resins derived from the diglycidyl ether of bisphenol A (DGEBA resins, R′═CH₃) and the resins derived from bisphenol F (R′═H), which can be described by the following general formula:

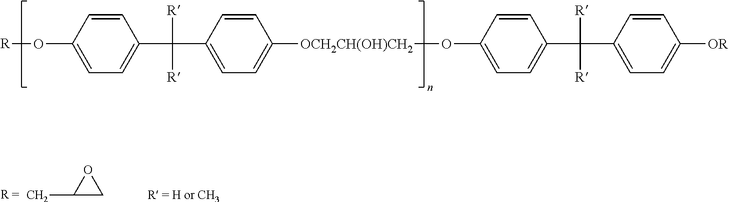

In the formula, the parameter n indicates the number of repeating units, with the average value of n corresponding to the respective average molecular weight.

Examples of epoxy resins based on polyglycidyl ethers of aromatic polyols are, furthermore, glycidyl ethers of phenol-based and cresol-based novolaks. Novolaks are prepared by the acid-catalyzed condensation of formaldehyde and phenol or cresol. Reacting the novolaks with epichlorohydrin produces the glycidyl ethers of the novolaks.

In another preferred embodiment of the invention the epoxy resin is selected from polyglycidyl ethers of cycloaliphatic polyols and from the polyglycidyl esters of cycloaliphatic polycarboxylic acids. Examples of polyglycidyl ethers of cycloaliphatic polyols are polyglycidyl ethers based on ring-hydrogenated bisphenol A, the polyglycidyl ethers based on ring-hydrogenated bisphenol F, polyglycidyl ethers based on ring-hydrogenated novolaks, and mixtures thereof. Examples of such products are P 22-00 from LeunaHarze and Eponex 1510 from Hexion. An example of polyglycidyl esters of cycloaliphatic polycarboxylic acids is diglycidyl hexahydrophthalate.

Also suitable as epoxy resins, furthermore, are polyacrylate resins containing epoxide groups. These resins are prepared generally by copolymerization of at least one ethylenically unsaturated monomer which comprises in the molecule at least one epoxide group, more particularly in the form of a glycidyl ether group, with at least one further ethylenically unsaturated monomer which comprises no epoxide group in the molecule; at least one of the comonomers is preferably an ester of acrylic acid or methacrylic acid. Examples of ethylenically unsaturated monomers which comprise at least one epoxide group in the molecule are glycidyl acrylate, glycidyl methacrylate, and allyl glycidyl ether. Examples of ethylenically unsaturated monomers which comprise no epoxide group in the molecule are alkyl esters of acrylic and methacrylic acid which comprise 1 to 20 carbon atoms in the alkyl radical, more particularly methyl acrylate, methyl methacrylate, ethyl acrylate, ethyl methacrylate, butyl acrylate, butyl methacrylate, 2-ethylhexyl acrylate, and 2-ethylhexyl methacrylate. Other examples of ethylenically unsaturated monomers which comprise no epoxide groups in the molecule are acids, such as acrylic acid and methacrylic acid, acid amides, such as acrylamide and methacrylamide, vinyl aromatic compounds, such as styrene, methylstyrene, and vinyltoluene, nitriles, such as acrylonitrile and methacrylonitrile, vinyl halides and vinylidine halides, such as vinyl chloride and vinylidine fluoride, vinyl esters, such as vinyl acetate, and hydroxyl-containing monomers, such as hydroxyethyl acrylate and hydroxyethyl methacrylate, for example. The epoxide-group-containing polyacrylate resin typically has an epoxide equivalent weight of 400 to 2500, preferably 500 to 1500, very preferably 600 to 1200. The number-average molecular weight (determined by gel permeation chromatography using a polystyrene standard) is typically in the range from 1000 to 15 000, preferably from 1200 to 7000, more preferably from 1500 to 5000. The glass transition temperature (TG) is typically in the range from 30 to 80° C., preferably from 40 to 70° C., more preferably from 50 to 70° C. (measured by means of differential calorimetry (DSC)). Polyacrylate resins containing epoxide groups are known (cf., e.g., EP-A-299 420, DE-B-22 14 650, DE-B-27 49 576, U.S. Pat. No. 4,091,048, and U.S. Pat. No. 3,781,379). Examples of such resins are Epon 8021, Epon 8111, Epon 8161 from Hexion.

The epoxy resins may also derive from other epoxides (nonglycidyl ether epoxy resins). These include, in particular, compounds, including oligomers and polymers, which have at least one, more particularly two or more, epoxidized cycloaliphatic groups, more particularly 7-oxabicyclo-[4.1.0]-heptyl groups, which are obtainable by epoxidation of compounds having cyclohexenyl groups. Examples of the epoxidation products of compounds having at least one cycloolefinic group are 4-epoxyethyl-1,2-epoxycyclohexane and the compound of the following formula:

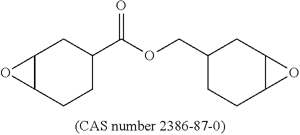 [SMILES: O=C(OCC1CCC2OC2C1)C1CCC2OC2C1]

which is sold, for example, by Cytec under the name Uvacure 1500. Preference is given to using the compounds which have at least one, more particularly two or more, epoxidized cycloaliphatic groups, more particularly 7-oxabicyclo-[4.1.0]-heptyl groups, which are obtainable by epoxidation of compounds having cyclohexenyl groups, and their oligomers, not alone but instead in combination with one or more of the aforementioned substances which have at least two glycidyl ether groups in the molecule.

Besides the epoxy resins and the compounds of the formula I, the epoxy resin component (a) may also comprise one or more conventional reactive diluents (constituent a3). By these are meant, in particular, low molecular weight compounds having a molecular weight of preferably not more than 400 daltons, e.g., in the range from 100 to 400 daltons, and which contain oxirane groups, preferably glycidyl groups, in the form, for example, of glycidyl ether groups, glycidyl ester groups or glycidyl amide groups. The epoxide functionality, i.e., the number of epoxide groups per molecule, in the case of the reactive diluents is typically in the range from 1 to 4, more particularly in the range from 1.2 to 3. Preferred among these are, in particular, glycidyl ethers of aliphatic or cycloaliphatic alcohols which have preferably 1, 2, 3 or 4 OH groups and 2 to 20 or 4 to 20 C atoms, and also glycidyl ethers of aliphatic polyetherols which have 4 to 20 C atoms. Examples of such are as follows:
glycidyl ethers of saturated monofunctional aliphatic alcohols having 2 to 20 C atoms, such as C₂-C₂₀-alkyl monoglycidyl ethers such as 2-ethylhexyl glycidyl ether, for example;
glycidyl ethers of saturated alkanepolyols having 2 to 20 C atoms, examples being the glycidyl ethers of 1,4-butanediol, 1,6-hexanediol, trimethylolpropane or of pentaerythritol, the aforementioned glycidyl ether compounds generally having an epoxide functionality in the range from 1 to 3.0 and preferably in the range from 1.2 to 2.5;
glycidyl ethers of polyetherols having 4 to 20 C atoms, examples being glycidyl ethers of diethylene glycol, triethylene glycol, tetraethylene glycol, dipropylene glycol or tri propylene glycol;
glycidyl ethers of cycloaliphatic alcohols having 5 to 20 C atoms, such as, for example, bisglycidyl ethers of cyclohexane-1,4-diyl, the bisglycidyl ether of ring-hydrogenated bisphenol A or of ring-hydrogenated bisphenol F;
glycidyl ethers of polyalkylene oxides having 2 to 4 C atoms such as polyethylene oxide or polypropylene oxide;
   and mixtures of the above substances.

Preferred reactive diluents are mono-, di-, and triglycidyl ethers of aliphatic or cycloaliphatic mono-, di- or trihydroxy compounds having 2 to 20 C atoms, and diglycidyl ethers of poly-C₂-C₄-alkylene ethers.

Where desired, the conventional reactive diluents are used in the epoxy resin component (a) in a total amount of at least 0.5 wt %, more particularly at least 1 wt %, based on the total weight of the epoxy resin component (a). In general, however, the conventional reactive diluents will be used in a total amount of not more than 50 wt %, more particularly not more than 20 wt %, based on the total weight of the epoxy resin component (a). The total amount of reactive diluent plus compound of the formula I will preferably not be more than 1 part by weight, more particularly not more than 0.8 part by weight, and especially not more than 0.5 part by weight, based on 1 part by weight of the epoxy resins a1). Where the epoxy resin component (a) comprises one or more conventional reactive diluents, the weight ratio of compound of the formula I to conventional reactive diluent is customarily in a range from 1:10 to 10:1, more particularly in the range from 1:5 to 5:1.

In accordance with the invention the epoxy resin component (a) comprises at least one compound of the general formula I. The proportion of the compounds of the formula I in the epoxy resin component is preferably in the range from 1 to 30 wt %, more particularly in the range from 2 to 20 wt %, based on the total weight of the epoxy resin component (a).

Preferred compounds of the formula (I) are those in which the radicals R¹, R², R³, and R⁴ independently of one another have one or more of the following definitions:
R¹ is selected from hydrogen, C₁-C₄-alkyl, such as methyl, ethyl, n-propyl or isopropyl, C₁-C₄-alkoxy-C₁-C₄-alkyl, C₅-C₆-cycloalkyl, e.g., cyclohexyl, phenyl, phenyl-C₁-C₄-alkyl, e.g., benzyl;
R² is selected from hydrogen, C₁-C₄-alkyl, such as methyl, ethyl, n-propyl or isopropyl, C₁-C₄-alkoxy-C₁-C₄-alkyl, C₅-C₆-cycloalkyl, e.g., cyclohexyl, phenyl, phenyl-C₁-C₄-alkyl, e.g., benzyl; or
R¹ and R² may also together be a C₃-C11-alkylene group, preferably a C₄-C₆-alkylene group, such as, for example, 1,4-butanediyl, 1,5-pentanediyl or 1,6-hexanediyl, more particularly a linear C₅-alkylene group (1,5-pentanediyl);
R³ is selected from hydrogen, C₁-C₄-alkyl, C₁-C₄-alkoxy-C₁-C₄-alkyl, C₅-C₆-cycloalkyl, phenyl, phenyl-C₁-C₄-alkyl, C₂-C₆-alkenyl, and C₂-C₆-alkynyl;
R⁴ is selected from hydrogen, C₁-C₄-alkyl, C₁-C₄-alkoxy-C₁-C₄-alkyl, C₅-C₆-cycloalkyl, phenyl, phenyl-C₁-C₄-alkyl, C₂-C₆-alkenyl, and C₂-C₆-alkynyl.
R³ and R⁴ may also together be a C₄-C₆-alkylene group, such as, for example, 1,4-butanediyl, 1,5-pentanediyl or 1,6-hexanediyl.

In particular, one or both radicals R¹ or R² are not hydrogen. In preferred compounds of the formula I, at least one of the radicals R³ and R⁴ is hydrogen. More preferably both radicals R³ and R⁴ are hydrogen.

With a view to the use in accordance with the invention, the compounds of the formula (I) particularly preferred are those in which the radicals R¹ and R² have the following definitions, where the radicals R³ and R⁴ have the definitions specified above, and preferably one of the radicals R³ or R⁴ is hydrogen, and more particularly both radicals R³ and R⁴ are hydrogen:
R¹ is selected from hydrogen and C₁-C₄-alkyl, more particularly hydrogen, methyl or ethyl;
R² is selected from C₁-C₄-alkyl, more particularly hydrogen, methyl or ethyl;

In a likewise particularly preferred embodiment of the invention, R¹ and R² independently of one another are C₁-C₄-alkyl, more particularly methyl or ethyl. In this especially preferred embodiment, the radicals R³ and R⁴ have the definitions specified above, and preferably at least one of the radicals R³ or R⁴ is hydrogen, and more particularly both radicals R³ and R⁴ are hydrogen.

Particularly preferred accordingly are compounds of the general formula Ia

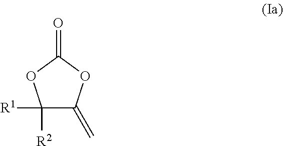

in which R¹ and R² have one of the definitions given above, and mixtures thereof. Particularly preferred compounds of the general formula la are those in which R¹ and R² exhibit the definitions described in table 1.

TABLE 1
Examples of compounds of the formula Ia

| No. | R¹ | R² |
|---|---|---|
| 1 | H | Methyl |
| 2 | Methyl | Methyl |
| 3 | n-Propyl | Methyl |
| 4 | Isopropyl | Methyl |
| 5 | n-Butyl | Methyl |
| 6 | Isobutyl | Methyl |
| 7 | H | Ethyl |
| 8 | Methyl | Ethyl |
| 9 | Ethyl | Ethyl |
| 10 | Isopropyl | Ethyl |
| 11 | n-Butyl | Ethyl |
| 12 | H | H |
| 13 | Methyl | H |
| 14 | n-Propyl | H |
| 15 | Isopropyl | H |
| 16 | n-Butyl | H |
| 17 | Isobutyl | H |

Particularly preferred among these are the following compounds and mixtures thereof:
4,4-Diethyl-5-methylene-1,3-dioxolan-2-one
4,4-Dimethyl-5-methylene-1,3-dioxolan-2-one
4-Methyl-5-methylene-1,3-dioxolan-2-one
4-Ethyl-5-methylene-1,3-dioxolan-2-one
4-Ethyl-4-methyl-5-methylene-1,3-dioxolan-2-one
4-Isopropyl-5-methylene-1,3-dioxolan-2-one
4-Isopropyl-4-methyl-5-methylene-1,3-dioxolan-2-one
4-Methylene-1,3-dioxaspiro[4.5]decan-2-one

Especially preferred compounds of the formula la are those where R¹ and R² independently of one another are C₁-C₄-alkyl, more particularly are methyl or ethyl.

The compounds of the formulae I and Ia, which are also referred to below as exo-vinylene carbonates, are known in principle from the prior art, as for example from DE 1098953 or DE 3433403.

Compounds of the formula I or Ia in which at least one of the two radicals R³, R⁴ is hydrogen may be prepared, for example, by reaction of optionally substituted propargyl alcohols with CO₂ or with a carboxylic anhydride in the presence of a catalyst, as is also described in WO 2011/157617.

Compounds of the formula I or Ia in which one or both radicals R³ or R⁴ is or are a radical other than hydrogen may be prepared starting from compounds of the formula I in which both radicals R³ and R⁴ are hydrogen by Heck coupling, as for example in analogy to the method described in Tetrahedron Lett. 2000, 5527-5531.

In preferred embodiments of the invention, the epoxy resin component (a) comprises:
a1) at least one epoxy resin from the group of the polyglycidyl ethers of aromatic polyols, more particularly at least one polyglycidyl ether of aromatic polyols derived from bisphenol A or from bisphenol F, and also
a2) at least one compound of the formula I, more particularly one of the compounds of the formula Ia identified as preferred, and especially a compound of the formula Ia in which stand for C₁-C₄-alkyl, more particularly for methyl or ethyl.

In further preferred embodiments of the invention, the epoxy resin component (a) comprises:
a1) at least one epoxy resin from the group of the polyglycidyl ethers of aromatic polyols, more particularly at least one polyglycidyl ether of aromatic polyols derived from bisphenol A or from bisphenol F,
a2) at least one compound of the formula I, more particularly one of the compounds of the formula Ia identified as preferred, and especially a compound of the formula Ia in which stand for C₁-C₄-alkyl, more particularly for methyl or ethyl; and also
a3) at least one reactive diluent, more particularly at least one reactive diluent selected from mono-, di-, and triglycidyl ethers of aliphatic or cycloaliphatic mono-, di- or trihydroxy compounds having 2 to 20 C atoms, and diglycidyl ethers of poly-C₂-C₄-alkylene ethers.

It has proven advantageous, moreover, if the epoxy resin compositions of the invention further comprise an aliphatic, cycloaliphatic or araliphatic mono- or dihydroxy compound having 6 to 10 C atoms, identified below as constituent d1). Examples of aliphatic and cycloaliphatic mono- and dihydroxy compounds having 6 to 10 C atoms are 1-hexanol, 1-heptanol, 1-octanol, hexanediol, 2-ethylhexan-1-ol, hydroxymethylcyclohexane, cyclohexanol, cycloheptanol, and bis(hydroxymethyl)-cyclohexane. Particular examples of araliphatic mono- and dihydroxy compounds having 6 to 10 C atoms are benzyl alcohol, 1-phenylethanol, 2-phenylethanol, and the isomers of bis(hydroxymethyl)benzene. Preferred among these are araliphatic monohydroxy compounds, especially benzyl alcohol. The constituent d1) may be formulated both in the epoxy resin component (a) and in the curing component (b). The major amount or total amount of the constituent d1) is preferably formulated in the curing component (b). The total amount of constituent d1), where desired, is in the range from 1 to 20 wt %, based on the total amount of the constituents a1), a2), b1), c1), and d1).

The epoxy resin component (a) may, furthermore, also comprise inert organic diluents. By these are meant organic solvents which at atmospheric pressure have a boiling point of below 200° C. and which do not enter into any bond-forming reaction with the epoxide groups and with the groups of any reactive diluent optionally present. Diluents of this kind are typically organic solvents, examples being ketones having preferably 3 to 8 C atoms such as acetone, methyl ethyl ketone, cyclohexanone, and the like, esters of aliphatic carboxylic acids, preferably of acetic acid, of propionic acid or of butanoic acid, more particularly the C₁-C₆-alkyl esters of these acids such as ethyl acetate, propyl acetate, and butyl acetate, aromatic hydrocarbons, especially alkylaromatics such as, for example, toluene, mesitylene, 1,2,4-trimethylbenzene, n-propylbenzene, isopropylbenzene, cumene, or xylenes, and mixtures of alkylaromatics, more particularly technical mixtures of the kind available commercially, for example, as Solvesso grades, and also aliphatic and cycloaliphatic hydrocarbons.

In one preferred embodiment, the epoxy resin component (a) comprises inert organic solvents at most in minor amounts (less than 20 wt %, more particularly of less than 10 wt % or less than 5 wt %, based on the total weight of the epoxy resin component (a), and more preferably they contain no such solvent (100% system).

Besides the aforementioned constituents, the epoxy resin component (a) may comprise the additives and/or fillers that are customary for it.

Examples of suitable fillers include inorganic or organic particulate materials such as, for example, calcium carbonates and silicates and also inorganic fiber materials such as glass fibers, for example. Organic fillers such as carbon fibers and mixtures of organic and inorganic fillers, such as mixtures of glass fibers and carbon fibers or mixtures of carbon fibers and inorganic fillers, for example, may also find application. The fillers can be added in an amount of 1 to 70 wt %, based on the total weight of the epoxy resin component (a).

Suitable conventional additives comprise, for example, antioxidants, UV absorbers/light stabilizers, metal deactivators, antistats, reinforcers, fillers, antifogging agents, blowing/propelling agents, biocides, plasticizers, lubricants, emulsifiers, colorants, pigments, rheological agents, impact tougheners, catalysts, adhesion regulators, optical brighteners, flame retardants, antidropping agents, nucleating agents, solvents and reactive diluents, and also mixtures of these.

The optionally used light stabilizers/UV absorbers, antioxidants, and metal deactivators preferably have a high migration stability and temperature stability. They are selected, for example, from groups a) to t). The compounds of groups a) to g) and i) constitute light stabilizers/UV absorbers, while compounds j) to t) act as stabilizers.

a) 4,4-diarylbutadienes,

b) cinnamic esters,

c) benzotriazoles,

d) hydroxybenzophenones,

e) diphenylcyanoacrylates,

f) oxamides,

g) 2-phenyl-1,3,5-triazines,

h) antioxidants,

i) nickel compounds,

j) sterically hindered amines,

k) metal deactivators,

l) phosphites and phosphonites,

m) hydroxylamines,

n) nitrones,

o) amine oxides,

p) benzofuranones and indolinones,

q) thiosynergists,

r) peroxide-destroying compounds,

s) polyamide stabilizers, and

t) basic costabilizers.

The epoxy resin compositions of the invention further comprise a curing component (b), which comprises at least one aminic curing agent, also referred to below as amine curing agent (constituent b1)). Amine curing agents crosslink epoxy resins through reaction of the primary or secondary amino functions of the polyamines with the epoxide groups of the epoxy resins. Amine curing agents of this kind typically have at least two primary or secondary amino groups, and generally they have 2 to 6, more particularly 2 to 4, primary or secondary amino groups.

Examples of customary amine curing agents are
aliphatic polyamines such as ethylenediamine, 1,2- and 1,3-propanediamine, neopentanediamine, hexamethylenediamine, octamethylenediamine, 1,10-diaminodecane, 1,12-diaminododecane, diethylenetriamine, triethylenetetramine, tetraethylenepentamine, tri methylhexamethylenediamine, 1-(3-aminopropyl)-3-aminopropane, 1,3-bis(3-aminopropyl)propane, 4-ethyl-4-methylamino-1-octyl-amine, and the like;
cycloaliphatic diamines, such as 1,2-diaminocyclohexane, 1,3-bis(aminomethyl)-cyclohexane, 1-methyl-2,4-diaminocyclohexane, 4-(2-aminopropan-2-yl)-1-methylcyclohexane-1-amine, isophoronediamine, 4,4′-diaminodicyclo-hexylmethane, 3,3′-dimethyl-4,4′-diaminodicyclohexylmethane, 4,8-diaminotricyclo[5.2.1.0]decane, norbornanediamine, menthanediamine, menthenediamine, and the like;
aromatic diamines, such as tolylenediamine, xylylenediamine, especially meta-xylylenediamine, bis(4-aminophenyl)methane (MDA or methylenedianiline), bis(4-aminophenyl) sulfone (also known as DADS, DDS or dapsone), and the like;
cyclic polyamines, such as piperazine, N-aminoethylpiperazine, and the like;
polyetheramines, especially difunctional and trifunctional primary polyetheramine based on polypropylene glycol, polyethylene glycol, polybutylene oxide, poly(l,4-butanediol), poly-THF or polypentylene oxide, e.g., 4,7,10-trioxatridecane-1,3-diamine, 4,7,10-trioxatridecane-1,13-diamine, 1,8-diamino-3,6-dioxaoctane (XTJ-504 from Huntsman), 1,10-diamino-4,7-dioxadecane (XTJ-590 from Huntsman), 1,12-diamino-4,9-dioxadodecane (BASF SE), 1,3-diamino-4,7,10-trioxatridecane (BASF), primary polyetheramines based on polypropylene glycol having an average molar mass of 230 such as, for example, polyetheramine D 230 (BASF SE) or Jeffamine® D 230 (Huntsman), difunctional, primary polyetheramines based on polypropylene glycol having an average molar mass of 400, e.g. polyetheramine D 400 (BASF SE) or Jeffamine® XTJ 582 (Huntsman), difunctional, primary polyetheramines based on polypropylene glycol having an average molar mass of 2000 such as, for example, polyetheramine D 2000 (BASF SE), Jeffamine® D2000 or Jeffamine® XTJ 578 (Huntsman), difunctional, primary polyetheramines based on propylene oxide having an average molar mass of 4000 such as, for example, polyetheramine D 4000 (BASF SE), trifunctional, primary polyetheramines prepared by reacting propylene oxide with trimethylolpropane followed by an amination of the terminal OH groups, having an average molar mass of 403, such as, for example, polyetheramine T 403 (BASF SE) or Jeffamine® T 403 (Huntsman), trifunctional, primary polyetheramines prepared by reacting propylene oxide with glycerol, followed by an amination of the terminal OH groups, having an average molar mass of 5000, such as, for example, polyetheramine T 5000 (BASF SE) or Jeffamine® T 5000 (Huntsman), aliphatic polyetheramines constructed from a propylene oxide-grafted polyethylene glycol and having an average molar mass of 600, such as, for example, Jeffamine® ED-600 or Jeffamine® XTJ 501 (each Huntsman), aliphatic polyetheramines constructed from a propylene oxide-grafted polyethylene glycol and having an average molar mass of 900, such as, for example, Jeffamine® ED-900 (Huntsman), aliphatic polyetheramines constructed from a propylene oxide-grafted polyethylene glycol and having an average molar mass of 2000, such as, for example, Jeffamine® ED-2003 (Huntsman), difunctional, primary polyetheramine prepared by amination of a propylene oxide-grafted diethylene glycol, having an average molar mass of 220, such as, for example, Jeffamine® HK-511 (Huntsman), aliphatic polyetheramines based on a copolymer of poly(tetramethylene ether glycol) and polypropylene glycol having an average molar mass of 1000 such as, for example, Jeffamine® XTJ-542 (Huntsman), aliphatic polyetheramines based on a copolymer of poly(tetra-methylene ether glycol) and polypropylene glycol having an average molar mass of 1900, such as, for example Jeffamine® XTJ-548 (Huntsman), aliphatic polyetheramines based on a copolymer of poly(tetramethylene ether glycol) and polypropylene glycol having an average molar mass of 1400 such as, for example, Jeffamine® XTJ-559 (Huntsman), polyethertriamines based on a butylene oxide-grafted alcohol having a functionality of at least three, having an average molar mass of 400, such as, for example, Jeffamine® XTJ-566 (Huntsman), aliphatic polyetheramines prepared by amination of butylene oxide-grafted alcohols having an average molar mass of 219, such as, for example, Jeffamine® XTJ-568 (Huntsman), polyetheramines based on pentaerythritol and propylene oxide having an average molar mass of 600 such as, for example, Jeffamine® XTJ-616 (Huntsman), polyetheramines based on triethylene glycol having an average molar mass of 148, e.g., Jeffamine® EDR-148 (Huntsman), difunctional, primary polyetheramines prepared by amination of a propylene oxide-grafted ethylene glycol, having an average molar mass of 176, such as, for example, Jeffamine® EDR-176 (Huntsman), and also polyetheramines prepared by amination of PolyTHF having an average molar mass of 250, e.g., PolyTHF-Amine 350 (BASF SE), and mixtures of these amines;
polyamidoamines (amidopolyamines), which are obtainable by the reaction of polycarboxylic acids, especially dicarboxylic acids such as adipic acid or dimeric fatty acids (e.g., dimeric linoleic acid), with low molecular mass polyamines, such as diethylenetriamine, 1-(3-aminopropyl)-3-aminopropane or triethylenetetramine, or other diamines, such as the aforementioned aliphatic or cycloaliphatic diamines, or are obtainable alternatively by Michael addition of diamines onto acrylic esters and subsequent polycondensation of the resulting amino acid esters; or
phenalkamines (also phenolalkanamines), by which are meant phenol or phenol derivatives which are substituted on at least one C atom of the ring system by hydrocarbon groups which contain primary or secondary amino groups; apart from the hydroxyl group of the phenol or phenol derivative and the primary or secondary amino groups, the phenalkamines contain no other functional groups. More particularly the phenalkamines contain both primary and secondary amino groups. Highly suitable phenalkamines comprise preferably a total of 2 to 10, more particularly 2 to 8, and, in one particular embodiment, 4 to 6 amino groups of this kind; the phenalkamines in question are preferably based on cardanol, which is present in cashew nut shell oil; cardanol-based phenalkamines are substituted on at least one, preferably on one to three, C atoms of the ring system by above-described, preferably aliphatic hydrocarbon groups comprising primary or secondary amino groups. More particularly these substituents are located in ortho- or para-position to the hydroxyl group; phenalkamines can be prepared by Mannich reaction from the phenol or phenol derivative, an aldehyde, and a compound having at least one primary or secondary amino group. The phenalkamines are therefore Mannich bases or adducts of amino compounds, more particularly of one of the above amino compounds, with epoxide compounds
   and also mixtures of the aforesaid amine curing agents.

The amine curing agent b1) preferably comprises as its main constituent at least one aliphatic, cycloaliphatic or araliphatic compound having 4 to 20 C atoms, more particularly 6 to 10 C atoms, which has 1, 2, 3 or 4 primary NH₂ groups. Compounds of this kind are also referred to below as main curing agents and account generally for at least 50 wt %, more particularly at least 70 wt %, based on the total amount of the amine curing agents. In curing agents of this kind, the primary NH₂ groups are bonded preferably to CH₂ groups. As well as the primary NH₂ groups, preferred curing agents of this kind may have one or more, e.g., 1, 2, 3 or 4, secondary or tertiary amino groups or hydroxyl groups. Apart from the primary, secondary, and tertiary amino groups and also the hydroxyl groups, the preferred curing agents preferably have no other functional groups.

Preferred main curing agents are, for example, linear or branched aliphatic amine compounds which contain two primary amino groups and otherwise no further functional groups, examples being C₂- to C₈-alkylenediamines, such as ethylenediamine, propylenediamine or butylenediamine.

Preferred co-curing agents are also, for example, aliphatic amine compounds which contain one or two primary amino groups and one or two hydroxyl groups and otherwise no further functional groups, examples being monoamines, such as C₂- to C₈-alkanolamines, such as ethanolamine, isopropanolamine.

Preferred main curing agents are also, for example, aliphatic amine compounds which contain a primary amino group and a tertiary amino group and otherwise no further functional groups. Examples include compounds of the formula II

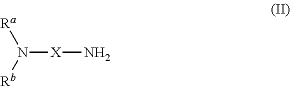

In formula II, R^{a} and R^{b} independently of one another are a C₁-C₁₀—, preferably a C₁-C₄-alkyl group. X is a C₂-C₁₀—, preferably a C₂-C₄-alkylene group. The alkylene group may be branched or linear; it is substituted at any location by the tertiary and the primary amino group. In one preferred embodiment the alkylene group is linear and is substituted terminally by the tertiary and primary amino group. As an example of one of the particularly preferred main curing agents here, mention may be made of 3-(dimethylamino)propylamine (DMAPA).

Preferred main curing agents are also aliphatic amine compounds which contain one or two primary amino groups, preferably one primary amino group, and a secondary amino group and an hydroxyl group, and otherwise no further functional groups. These are, more particularly, N-(2-aminoalkyl)alkanolamines, e.g., N-(2-aminoethyl)ethanol-amine (H₂N—CH₂—CH₂NH—CH₂—CH₂—OH). The two alkylene groups in these compounds preferably consist of 2 to 8 C atoms.

Preferred araliphatic main curing agents are, for example, benzene substituted by one, two or three aminomethylene groups (H₂N—CH₂—). More particularly they comprise benzene substituted by two H₂N—CH₂— groups at any desired position on the benzene ring, an example being meta-xylylenediamine with the formula

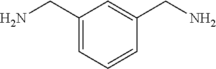

Preferred cycloaliphatic main curing agents are also, for example, cyclohexane substituted by one to three aminomethylene groups (H₂N—CH₂—). More particularly they comprise cyclohexane substituted by two H₂N—CH₂— groups at any desired position on the benzene ring.

Also contemplated, of course, are any desired mixtures of the main curing agents above.

The main curing agents preferably have a molecular weight of less than 500 g/mol, more particularly less than 300 g/mol. Preferred main curing agents have a total of 10 C atoms at most.

Of the main curing agents stated above, preference is given to the araliphatic compounds and mixtures thereof with one or more aliphatic or cycloaliphatic main curing agents. With particular preference the amine curing agent b1) comprises as its main constituent, i.e., to an extent of at least 50 wt %, more particularly at least 70 wt %, based on the total amount of amine curing agents, at least one araliphatic compound, more particularly at least one benzene substituted by two or three aminomethylene groups (H₂N—CH₂—), and especially meta-xylylenediamine.

Besides the compounds specified as main curing agents, the amine curing agent may comprise one or more of the aforementioned amine curing agent substances which do not fall within the above definition of the main curing agents; these agents, as observed above, are referred to below as co-curing agents. The proportion of these co-curing agents is then, accordingly, not more than 50 wt %, more particularly not more than 30 wt %, e.g., in the range from 1 to 50 wt %, more particularly 2 to 30 wt %, based on the sum total by weight of all amine curing agents. Examples of such co-curing agents are polyamidoamines, phenalkamines, epoxy-amine adducts, polyetheramines or other amine compounds different from the main curing agents, or mixtures thereof. With preference the co-curing agents are polyamidoamines, phenalkamines, epoxy-amine adducts, polyetheramines or mixtures thereof.

Besides the amine curing agents b1), the constituent c1) optionally formulated in the curing component (b), and the constituent d1) optionally formulated in the curing component (b), the curing component (b) may comprise further constituents. Examples of such constituents that are contemplated are the additives referred to above in connection with the epoxy resin component (a). Also contemplated as further constituents of this kind are catalysts which accelerate the curing reaction, examples being phosphonium salts of organic or inorganic acids, imidazole and imidazole derivatives, or quaternary ammonium compounds. The catalysts (also called accelerators) are used, where desired, in proportions of 0.01 wt % to about 10 wt %, based on the total weight of the constituents a1), a2), b1), c1), and d1). In one preferred refinement no catalysts are needed, meaning that the amount of catalysts in the composition is less than 0.01 wt %, based on the total weight of the constituents a1), a2), b1), c1), and d1).

The amount of amine curing agent b1) needed for curing is determined in a known way via the number of epoxide groups in the formulation and the number of functional groups in the curing component (b). The number of epoxide groups in the epoxy resin is stated in the form of the so-called epoxide equivalent. The epoxide equivalent is determined in accordance with DIN 16945. The number of primary and secondary amino groups can be calculated via the amine number in accordance with DIN 16945.

The amine curing agents b1) are used in amounts such that the molar ratio of the number of all primary and secondary amino groups to the total number of all epoxide groups in the epoxy resin a1) and in the reactive diluent a3) plus the number of moles of the compound 1 is in the range from 2:1 to 1:2, preferably in the range from 1.5:1 to 1:1.5, and more particularly about 1:1. At a stoichiometric ratio of about 1:1, a cured resin is obtained which has optimum thermoset properties. Depending on the desired properties of the resin after crosslinking, however, it may also make sense to use curing agent and epoxy resin in different reactive-group proportions.

In the epoxy resin compositions of the invention, the total amount of amine curing agent b1) is generally 0.1 wt % to 50 wt %, frequently 0.5 to 40 wt %, and more particularly 1 to 30 wt %, based on the sum total by weight of epoxy resin a1), compound of the formula I, the optionally present reactive diluent a3), amine curing agent b1), and the constituent c1).

Besides the amine curing agent a1) used in accordance with the invention there may also be other curing agents used as well, examples being anhydride curing agents. In one preferred embodiment, however, exclusively amine curing agents a1) are used for the curing.

To cure the epoxy resin composition of the invention, the epoxy resin component (a) is mixed with the curing component (b) in a known way.

As already mentioned, components (a) and (b) of the epoxy resin composition of the invention are generally formulated separately, i.e., as a multicomponent kit, more particularly as a two-component kit (preferably a two component kit with components (a) and (b)).

A multicomponent kit is more particularly understood to be a two-component kit (preferably a two-component kit with components (a) and (b)), preferably a two-chamber or, further, multichamber device, in which the mutually reactive components (a) and (b) are present in such a way that they are unable to react with one another during storage, preferably such that they do not come into contact with one another before use. Particularly suitable are capsules, made for example of plastic, ceramic or, in particular, glass, in which the components are arranged separated from one another by boundary walls which can be destroyed (for example, when an anchor is driven into a recess, such as a drilled hole)-in the form, for example, of nested capsules, such as ampoules, film pouches having two or more chambers, or containers such as pails or troughs having a plurality of chambers, or sets (e.g., drums or cans) of two or more such containers, where two or more components of the respective curable composition, more particularly two components (a) and (b) as defined above and below, are present each spatially separate from one another in the form of a kit or set, in which the contents, after mixing or during mixing, are conveyed to the site of use (more particularly by means of apparatus for application such as trowels or brushes or a static mixer), as for example an area for the fastening of fibers, scrims, woven fabrics, composites or the like, or into a recess, such as a drilled hole, in particular for the fastening of anchors such as anchor rods or the like; and also multicomponent or, in particular, two-component cartridges, their chambers comprising the plurality of or, preferably, two components (more particularly (a) and (b)) for a curable composition for fastening use, with compositions specified above and below, for the purpose of keeping prior to utilization, in which case the kit in question preferably also includes a static mixer. In the cases of the film pouches and of the multicomponent cartridges, an emptying device may also belong to the multicomponent kit, although it may preferably also be independent of the kit (for the purpose of multiple use, for example). In the multicomponent kit, more particularly in the two-component kits, as described above and below, the mass ratio of the components (a) to (b) in one favorable embodiment of the invention is 10:1 or less, more particularly 5:1 or less, preferably 4:1 or less, with the lower limit being situated advantageously in each case at 1:2, more particularly at 1:1. The mass ratio of epoxy resin component (a) to the curing component (b) is in particular about 2.5:1 to 3.5:1.

The epoxy resin compositions of the invention are suitable in principle for all applications for which epoxy resin compositions are customarily in use. These include their use in coating materials, in casting compositions, for producing composite materials, and in structural adhesives.

According to one preferred embodiment, the epoxy resin compositions of the invention find use in injection mortars. As already mentioned in the introduction, injection mortars are used for chemical fastening or anchoring technology. For this purpose components (a) and (b) of the multicomponent composition of the invention, together with an anchoring element, such as a metal pin, a metal rod, anchor pin or metal hooks, for example, are introduced into a recess, such as a drilled hole, for example, that is present in a substrate, preferably a mineral substrate, as for example stone or, in particular, concrete. On curing of the epoxy resin component (a), a firm bond is formed between the anchoring element and the substrate. The introduction of the component (a) and (b) and also of the anchoring element may in principle take place simultaneously or in succession. For example, components (a) and (b) may be introduced first of all into the recess, and then the anchoring element may be inserted into the recess filled at least partly with the multicomponent epoxy resin composition. The opposite procedure is also possible, with the anchoring element insertable first into the recess, followed by the possible introduction of components (a) and (b) into the remaining space in the recess. Suitable for this purpose in principle are the aforementioned capsule systems, and also the injection systems.

The examples which follow serve to illustrate the invention but should not be interpreted restrictively.

The starting products used were as follows:

Epoxy resin 1 (EH1): Aromatic epoxy resin based on bisphenol A with an epoxide equivalent of 182-192 g/eq and a viscosity at 25° C. in the range of 10-14 Pas (Epilox A 19-03).

Epoxy resin 2 (EH2): Aromatic epoxy resin based on bisphenol F with an epoxide equivalent of 167-173 g/eq and a viscosity at 25° C. in the range of 2.5-4.0 Pas (Epilox F17-00).

Reactive diluent 1 (RV1): Monoglycidyl ether of a C₁₂-C₁₄ alcohol: epoxide equivalent of 282 g/eq (Epilox P13-18).

Reactive diluent 2 (RV2): Diglycidyl ether of 1,6-hexanediol: epoxide equivalent of 147 g/eq (Epilox P13-20).

Reactive diluent 3 (RV3): Triglycidyl ether of trimethylolpropane: epoxide equivalent of 143 g/eq (Epilox P13-30).

Reactive diluent 4 (RV4): Diglycidyl ether based on polyoxypropylene glycol: epoxide equivalent of 335 g/eq (Epilox P13-42).

Compound I (AX1): 4,4-Dimethyl-5-methylene-1,3-dioxolan-3-one.

Aliphatic polyetheramine polyol (PEAOH): Polymer based on triethanolamine; number-average molecular weight 4000-5000 g/mol, weight-average molecular weight 8000-9000 g/mol, OH number 580-600 mg KOH/g (determined according to DIN 53240).

Aliphatic polyalkylene ether polyol (PTHF): PolyTHF® from BASF SE; Mn=1000 g/mol).

Additive 1: Polyquaternium-86 (PQ86): Quaternary polymer surfactant (Luvigel Advanced from BASF SE).

Additive 2: Benzyl alcohol.

MXDA: meta-Xylylenediamine.

The ingredients were mixed to produce the epoxy resin components a) specified in table 1 and the curing components b) specified in table 2. The average epoxide equivalent EEWφ) was calculated from the epoxide equivalents of the constituents, on the basis of an epoxide equivalent of 71 g/eq for AX1.

The viscosities of the curing and epoxy resin components were measured on a shear rate-controlled plate/plate rheometer (MCR 301, Anton Paar) having a plate diameter of 25 mm and a slot spacing of 0.25 mm at 23° C. and a shear rate of 100 s⁻¹.

TABLE 1
Epoxy resin components (a)

| Resin | EH1 | EH2 | Reactive diluent | | AX1 | EEWφ¹⁾ | Viscosity |
|---|---|---|---|---|---|---|---|
| # | [g] | [g] | Type | [g] | [g] | [g/eq] | [mPas] |
| 1 | 90 | — | — | — | 10 | 157 | 2500-3000 |
| 2 (C) | 90 | — | RV1 | 10 | — | 189 | 2000-2200 |
| 3 | 85 | — | RV2 | 5 | 10 | 156 | 1550-1650 |
| 4 | 55 | 30 | RV3 | 5 | 10 | 152 | 1600-1650 |
| 5 | 60 | 25 | RV4 | 5 | 10 | 157 | 1500-1550 |
| 6 | 60 | 25 | RV2 | 5 | 10 | 153 | 1250-1300 |
| 7 | 90 | — | RV4 | 5 | 5 | 172 | 3500-4100 |

¹⁾Average epoxide equivalent

TABLE 2
Curing components (b)

| Curing | | | | | Additive | | |
|---|---|---|---|---|---|---|---|
| agent | MXDA | PEAOH | PTHF | AX1 | Type/ | AHEWφ²⁾ | Viscosity |
| # | [g] | [g] | [g] | [g] | [g] | [g/eq] | [mPas] |
| 1 | 22.0 | 11.0 | — | — | — | 51 | 150-160 |
| 2 | 21.9 | 9.0 | — | — | 1/2.4 | 52 | 500-550 |
| 3 | 21.9 | 5.7 | — | — | 2/5.7 | 52 | 50-100 |
| 4 | 21.9 | — | 11.4 | — | —/— | 52 | 50-100 |
| 5 | 21.9 | — | 5.7 | — | 1/5.7 | 52 | 400-450 |
| 6 (C) | 21.9 | — | — | — | 2/11.4 | 52 | 10-20 |
| 7 | 21.9 | 4.0 | — | 3.4 | 2/3.4 | 56 | 50-100 |

²⁾Average amine-hydrogen equivalent

The epoxy resin compositions of the invention were produced by mixing stoichiometric amounts of the epoxy resin components (a) and curing components (b) and were investigated immediately. The mixing ratio MR in g of component (a) to g of component (b) is reported in table 3. The following investigations were carried out; the results are compiled in table 3.
1) Determination of gel times (gel point GP): The gel times were determined by means of rheological measurements. For this purpose the compositions were investigated on a shear rate-controlled plate/plate rheometer (MCR 301, Anton Paar) having a plate diameter of 15 mm and a slot space of 0.25 mm at different temperatures. Measurement was carried out in rotary oscillation at 10° C. and 40° C. The point of intersection of loss modulus (G″) and storage modulus (G′) gave the gel time (gel point in h).
2) Determination of glass transition temperature T_{g}: The glass transition temperature was determined by differential scanning calorimetry (DSC) in accordance with ASTM D3418, using the following temperature profile: heating from 0 to 180° C.: heating rate 5 K/min; 180° C. conditioning for 30 min; cooling to 0° C. at 20 K/min; renewed heating to 220° C. at 20 K/min.
3) Shore D hardness (S_{D}): The Shore D hardness took place on samples fully cured at 23° C. for 48 hours, at 23° C. by means of a durometer (TI Shore test stand, Sauter Messtechnik).
4) Bond stress: The bond stress was determined by axial tensile tests in accordance with ETA 001-5, (table 5.6, line 2 (A2 conf)). For this purpose, drilled holes with a diameter of 14 mm and a depth of 72 mm were made into cylindrical concrete test specimens (d 115 mm, h 150 mm). The drilled holes were cleaned by being blown out twice with compressed air (6 bar), then brushed out twice, and again blown out twice with compressed air. The epoxy resin component (a) and the curing component (b) were introduced into a volumetric beaker, homogenized with a stirring device for 45 seconds, and placed into the drilled hole. Thereafter, within 3 minutes counted from the mixing of the components, a stainless steel anchor (threaded rod M12) having a seated depth of 70 mm was introduced into the drilled hole. The tensile experiments were carried out after a full-cure time of at least 44 hours at 20° C. using a hydraulic hollow piston. All of the experiments were repeated three times.

TABLE 3

| | | Curing | MR | GP_{(10° C.)} | GP_{(40° C.)} | T_{g} | | Bond stress |
|---|---|---|---|---|---|---|---|---|
| Ex. | Resin | agent | [g/g] | [min] | [min] | [° C.] | S_{D} | [N/mm²] |
| 1 | 3 | 1 | 3.055 | 420 | 73 | 79 | 92 | 29.8 |
| 2 | 4 | 1 | 2.982 | 415 | 79 | 83 | 89 | 28.8 |
| 3 | 5 | 1 | 3.087 | 452 | 80 | 79 | 92 | 34.3 |
| 4 | 6 | 1 | 2.997 | 423 | 83 | 81 | 93 | 28.8 |
| 5 | 3 | 2 | 2.996 | 374 | 83 | 87 | 88 | |
| 6 | 5 | 2 | 3.028 | — | — | — | — | 33.5 |
| 7 | 3 | 3 | 2.996 | 446 | 79 | 80 | 92 | 37.6 |
| 8 | 4 | 3 | 2.924 | 443 | | 82 | | 35.7 |
| 9 | 5 | 3 | 3.028 | 473 | | 77 | | 37.8 |
| 10 | 3 | 5 | 2.996 | 449 | 78 | 94 | 92 | |
| 11 | 5 | 1 + 3 - | 3.0 | — | — | — | — | 34.8 |
| | | 1:2 | | | | | | |
| 12 | 5 | 1 + 3 - | 3.0 | — | — | — | — | 34.1 |
| | | 1:1 | | | | | | |
| C13 | 2 | 3 | 3.630 | — | — | 82 | — | 30.4 |
| 14 | 1 | 3 | 3.310 | 408 | — | 86 | — | 38.9 |
| C15 | 5 | 6 | 3.310 | 505 | — | 83 | — | 31.9 |
| 16 | 5 | 3 + 6 | 3.310 | 484 | — | 81 | — | 39.3 |
| | | 1:1 | | | | | | |
| 17 | 5 | 3 + 6 | 3.310 | 490 | — | 78 | — | 36.6 |
| | | 1:2 | | | | | | |
| 18 | 7 | 3 | 3.020 | 579 | — | 83 | — | 34.9 |
| 19 | 7 | 7 | 3.080 | 463 | — | 90 | — | 36.8 |
| 20 | 5 | 7 | 3.380 | 378 | — | 84 | — | 32.4 |

MR: Mass ratio
GP_{(10° C.)}: Gel point at 10° C.
GP_{(40° C.)}: Gel point at 40° C.
T_{G}: Glass transition temperature
S_{D}: Shore D hardness

1. A multicomponent epoxy resin composition, comprising:
a) at least one epoxy resin component which comprises:
a1) at least one epoxy resin; and
a2) at least one compound of the general formula; 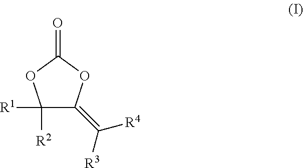
wherein R¹ and R² independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R¹ and R² together are a C₃-C₁₁-alkylene group; and
R³ and R⁴ independently of one another are hydrogen, C₁-C₆-alkyl, C₁-C₄-alkoxy-C₁-C₄-alkyl, C₅-C₆-cycloalkyl, phenyl, phenyl-C₁-C₄-alkyl, C₂-C₆-alkenyl or C₂-C₆-alkynyl, or R³ and R⁴ together are a C₄-C₆-alkylene group; and
b) at least one curing component which comprises:
b1) at least one amine curing agent;
wherein the epoxy resin component, the curing component, or both comprise at least one further constituent c1) selected from the group consisting of aliphatic polyether polyols, aliphatic polyetheramine polyols, and mixtures thereof.

2. The epoxy resin composition according to claim 1, wherein the aliphatic polyether polyol is polytetrahydrofuran.

3. The epoxy resin composition according to claim 1, wherein the aliphatic polyetheramine polyol is a branched poly-C₂-C₄-alkylene ether amine polyol.

4. The epoxy resin composition according to claim 1, wherein the aliphatic polyetheramine polyol is obtainable by condensation of a tri-C₂-C₄-alkanolamine.

5. The epoxy resin composition according to any one of claim 1, wherein the constituent c1) comprises at least one aliphatic polyetheramine polyol as main constituent.

6. The epoxy resin composition according to any one of claim 1, wherein in formula I the radical R¹ is selected from hydrogen or C₁-C₄-alkyl and the radical R² is selected from C ₁-C₄-alkyl.

7. The epoxy resin composition according to any one of claim 1, wherein in formula I the radicals R³ or R⁴ are hydrogen.

8. The epoxy resin composition according to claim 1, further comprising an aliphatic, cycloaliphatic or araliphatic mono- or dihydroxy compound having 6-10 C atoms.

9. The epoxy resin composition according to claim 1, wherein the proportion of the compounds of formula I in the epoxy resin component is in the range from 1 to 30 wt % based on the total weight of the epoxy resin component.

10. The epoxy resin composition according to claim 1, wherein the major amount of the further constituent c1) is present in the curing component b).

11. The epoxy resin composition according to claim 1, wherein the further constituent c1) making makes up 0.5 to 20 wt % based on the total weight of components a) and b).

12. The epoxy resin composition according to claim 1, wherein the epoxy resin a1) comprises at least one polyglycidyl ether of an aromatic polyol.

13. The epoxy resin composition according to claim 12, wherein the polyglycidyl ether of an aromatic polyol is selected from the group consisting of polyglycidyl ethers of bisphenol A, polyglycidyl ethers of bisphenol F, and mixtures thereof.

14. The epoxy resin composition according to claim 12, wherein the epoxy resin further comprises not only the at least one at least one reactive diluent.

15. The epoxy resin composition according to claim 14, wherein the reactive diluent being is selected from the group consisting of mono-, di-, and triglycidyl ethers of aliphatic or cycloaliphatic mono-, di-, or trihydroxy compounds having 2 to 20 C atoms, diglycidyl ethers of poly-C₂-C₄-alkylene ethers, and mixtures thereof.

16. The epoxy resin composition according to claim 1, wherein the amine curing agent b1) comprises as main constituent at least one aliphatic, cycloaliphatic or araliphatic compound having 4 to 20 C atoms which has 1, 2, 3, or 4 primary NH₂ groups.

17. The epoxy resin composition according to claim 1, wherein the amine curing agent b1) comprises as main constituent meta-xylylenediamine.

18. A kit, comprising:
the epoxy resin composition according to claim 1.
wherein the at least one epoxy resin component a) and the curing component b) are separate.

19. A method for curing the epoxy resin compositions according to claim 1, comprising:
mixing the epoxy resin component a) with the curing component b).

20. The epoxy resin compositions according to claim 1, wherein the composition is selected from the group consisting of chemical fastening compositions, injection mortars compositions, coating materials compositions, casting compositions, composite materials compositions, structural adhesives compositions, and mixtures thereof.

21. A method for anchoring an article, comprising:
introducing an anchor into a recess; and
introducing the multicomponent epoxy resin composition according to claim 1 into the recess.

22. The method according to claim 21, wherein the recess is a drilled hole in a mineral body.
